(19) United States
(12) Patent Application Publication
(10) Pub. No.: US 2015/0239010 A1
(43) Pub. Date: Aug. 27, 2015

(54) METHOD OF FORMING AN ABRADABLE COATING FOR A GAS TURBINE ENGINE

(71) Applicant: Pratt & Whitney Canada Corp., Longueuil (CA)

(72) Inventor: Kin-Leung Cheung, Toronto (CA)

(73) Assignee: Pratt & Whitney Canada Corp., Longueuil (CA)

(21) Appl. No.: 14/190,422

(22) Filed: Feb. 26, 2014

(51) Int. Cl. B05D 5/00

(52) U.S. Cl. CPC B05D 5/00

(57) ABSTRACT

A method of forming an abradable coating on a gas turbine engine component comprising, in sequence: placing dry lubricant particles and trapping particles in a channel having a spraying end and containing a gas; causing at least one shockwave in the gas to travel in the channel toward the spraying end, the at least one shockwave causing the dry lubricant particles and the trapping particles to travel in the channel with it, the at least one shockwave reducing interparticle spacing and increasing particles density; directing a resulting flow of the dry lubricant particles and the trapping particles from the spraying end at a supersonic velocity to impact the component; and then plastically deforming the trapping particles upon impacting the component with the resulting flow thereby trapping the dry lubricant particles with the deformed trapping particles onto the component to provide the abradable coating.

### TECHNICAL FIELD

The application relates generally to abradable coatings in gas turbine engine components and more specifically to methods of forming abradable coatings.

### BACKGROUND OF THE ART

Abradable surfaces are commonly found in gas turbine engines, for instance where a minimal clearance is needed (e.g., between blade tips and casing). In such cases, the casing has an abrabable coating that will wear upon contact with the blade tips. To form an abradable coating, dry lubricant particles are coated onto a component. If using conventional cold spray coating, the high speed imparted to the dry lubricant particles may cause the dry lubricant particles to shatter upon impact with the component. In turn, the dry lubricant particles do not adhere to the component. If using plasma spray, the high temperature decomposes the dry lubricant particles, which may lose their dry lubricant properties.

### SUMMARY

In one aspect is provided a method of forming an abradable coating on a gas turbine engine component, the method comprising, in sequence: placing dry lubricant particles and trapping particles in a channel having a spraying end and containing a gas; causing at least one shockwave in the gas to travel in the channel toward the spraying end, the at least one shockwave causing the dry lubricant particles and the trapping particles to travel in the channel with it, the at least one shockwave reducing interparticle spacing and increasing particles density; directing a resulting flow of the dry lubricant particles and the trapping particles from the spraying end at a supersonic velocity to impact the component; and then plastically deforming the trapping particles upon impacting the component with the resulting flow thereby trapping the dry lubricant particles with the deformed trapping particles onto the component to provide the abradable coating.

In another aspect, there is provided, a method of forming an abradable coating on a gas turbine engine component, the method comprising supersonically spraying dry lubricant particles and trapping particles at the component to plastically deform the trapping particles upon the component to trap the dry lubricant particles, the trapped dry particles providing the abradable coating.

### DESCRIPTION OF THE DRAWINGS

Reference is now made to the accompanying figures in which:

FIG. 1 is a schematic cross-sectional view of a gas turbine engine;

FIG. 2 is a schematic of compression wave generator forming an abradable coating for use in an engine such as the engine of FIG. 1;

FIG. 3a is a cross-sectional view of an example of abradable coating formed by the compression wave generator of FIG. 2;

FIG. 3b is a close-up view of FIG. 3a; and

FIG. 4 is a flow chart of a method of forming an abradable coating, such as the abradable coating of FIG. 3a using the compression wave generator of FIG. 2.

### DETAILED DESCRIPTION

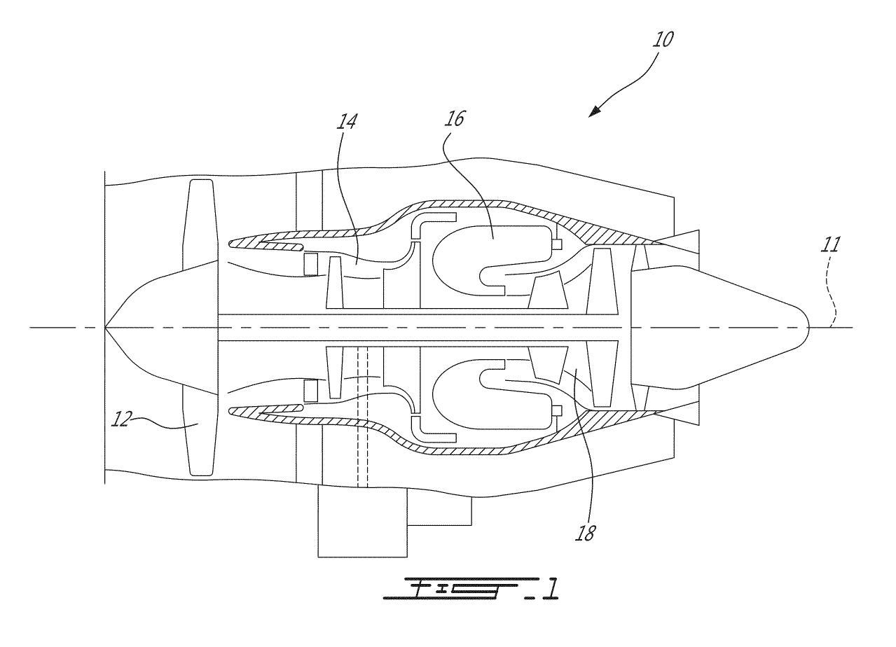

FIG. 1 illustrates a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. Some components of the engine 10 have abradable surfaces that may be formed by coating dry lubricant thereonto.

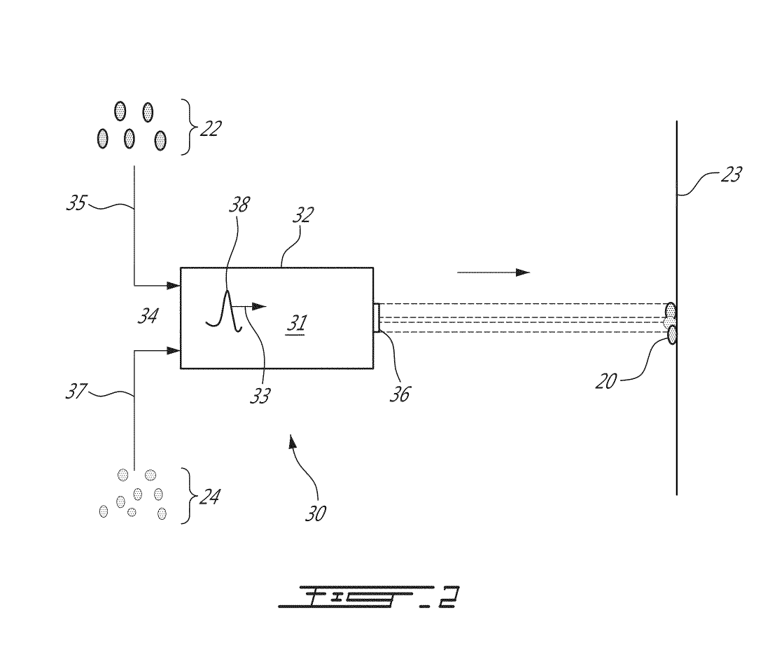

Referring to FIG. 2, an abradable coating 20 is made by bonding dry lubricant particles 22 onto a component 23 using projected trapping particles 24. The trapping particles 24 trap the dry lubricant particles 22 as they impact the component 23. The component 23 could be made of any suitable material for the desired application. For example, it could be a metal, an alloy or a polymer composite.

A shockwave generator 30 projects a flow of the dry lubricant particles 22 and trapping particles 24 onto the component 23. The shockwave generator 30 includes a channel 32, an inlet 34 and an opposed spraying end 36. An example of shockwave generator 30 is described in U.S. Pat. No. 8,298,612. The channel 32 is a tubular member circular in cross-section, but it is contemplated that the channel 32 could be rectangular, square or any cross-section adapted to form the abradable coating 20. The channel 32 is chosen to be suitable for the travel of compression waves/shockwave, (a schematic of a shockwave being shown in FIG. 2 with reference numeral 38). The channel 32 may be straight or bent, may or not be uniform in cross-section and may be made of material including but not limiting to metal, plastics, polymer, resin or alloys. The channel 32 has a length dependent on the nature of the dry lubricant particles 22 and trapping particles 24 used, as well as on the velocity desired at the spraying end 36 and temperature to obtain the desired coating. In one example, the length of the channel 32 is between 1 cm to 2 m long. Although, the channel 32 is shown herein to be rigid, it is contemplated that it could be flexible.

The channel 32 may contain an inert gas 31 such as helium or nitrogen. When no compression wave is generated, the gas 31 is quiescent and confined within the channel 32. The gas 31 may be a mixture of gas, and may also not be an inert gas. The gas 31 may be pressurised at a pressure above 150 kPa and may be at a temperature above 0 degrees Celsius. The gas 31 may be pre-heated, though at a temperature that would not alter the dry lubricant properties of the dry lubricant particles 22.

The inlet 34 receives two streams 35, 37 of particles. Each stream 35, 37 includes a different type of particles. The stream 35 includes the trapping particles 24 and the stream 37 includes the dry lubricant particles 22. It is contemplated that the inlet 34 could receive more than two streams of particles. For example, the inlet 34 could receive three streams, each of different particles. It is also contemplated that the inlet 34 could receive only one stream of particles, and that the stream would already contain a mixture of two or more particles 24, 22. It is also contemplated that each stream 35, 37 could include a mixture of particles. Having two distinct streams 35, 37 however facilitates the control of a proportion of dry lubricant particles 22 to trapping particles 24 during operation of the shockwave generator 30 which in turn creates a graded abradable coating 20. The dry lubricant particles 22 may be hexagonal boron nitride or talc. The dry lubricant particles 22 (also sometimes referred to as solid lubricant) are the particles that will constitute the abradable coating 20 on the component 23. Dry lubricant particles 22 in general are thermal sensitive. Above a predetermined temperature, the particles 22 decompose and oxidize, and may alter their dry lubricant properties. If mixed with other particles (e.g. the trapping particles 24) above a predetermined temperature, they could even react with these particles. As a consequence, a temperature of the gas 31 in the shockwave generator 30 is below the predetermined temperature at which the dry lubricant particles 22 chemically decompose before and after passage of the shockwave 38.

Dry lubricant particles 22 in general have a layered structure and a low shear strength. If projected at high speed against a surface, they may explode or shatter into numerous particles of smaller sizes (i.e. shear fracture at the molecular layers that were held together by weak Van der Walls forces). These numerous particles of smaller sizes by themselves do not adhere to the component 23. Therefore, high speed projection of dry lubricant particles 22 onto the component 23 without the trapping action of the trapping particles 24, as described below, would not result in an abradable coating.

The trapping particles 24 are chosen to be plastically deformable. By being plastically deformable and thus deforming at impact with the component 23, the trapping particles 24 traps the dry lubricant 22 by mechanical interlock to the component 23 or onto the deposited coating.

Although not necessary, the dry lubricant particles 22 may have a nominal size such that the trapping particles 24 have a larger surface area than the dry lubricant particles 22 when impacted onto the component 23. At the inlet 34, the trapping particles 24 may be smaller or bigger than the dry lubricant particles 22. In some cases, smaller trapping particles 24 can have a larger surface area than the dry lubricant particles 22 when impacting the component 23. The trapping articles 24 may have a smaller surface area at impact than the dry lubricant particles 22 if the proportion of trapping particles 24 to dry lubricant particles 22 compensates for that smaller surface area at impact.

In one embodiment, the trapping particles 24 are metal particles, but it is contemplated that the trapping particles 24 could be other material, e.g. polymer, as long as they deform plastically at impact. The trapping particles 24 may be commercial pure aluminum. The type of trapping particles 24 and component 23 used will determine if the bonding between the trapping particles 24 and component 23 is mechanical, metallurgical or both.

A proportion of dry lubricant particles 22 to trapping particles 24 is chosen so that enough dry lubricant particles 22 are trapped by the trapping particles 24 onto the component 23 to create the abradable coating 20. The lesser trapping particles 24, the more losses of dry lubricant particles 22 there may be. For example, a 50-50 composition of dry lubricant particles 22 to trapping particles 24 may trap between 60 and 80% of the dry lubricant particles 22, inducing a loss of dry lubricant particles 22 between 20 and 40%. In another example, a 20-80 composition of dry lubricant particles 22 to trapping particles 24 may trap between 90 and 100% of the dry lubricant particles 22, inducing a loss of only 0 to 10% of dry lubricant particles 22.

When the dry lubricant particles 22 and trapping particles 24 are fed to the channel 32 via the inlet 34, a shockwave 38 or a plurality of compression waves are created. If the shockwave 38 is not created at the onset, the plurality of compression waves will eventually coalesce into a shockwave as they travel toward the spraying end 36. The inlet 34 may be controlled by a valve (not shown). The opening of the valve may create the shockwave 38 or plurality of compression waves. Each shockwave 38/compression waves compresses the volume of gas 31 containing the dry lubricant particles 22 and trapping particles 24, thereby reducing the interparticle spacing. Having a sufficient small interparticle spacing allows ejecting the trapping particles 24 and the dry lubricant particles 22 almost instantaneously so that they impact the component at sufficient close proximity, whereby a majority of the impact shattered dry lubricant particles 22 before dispersed away from the surface are instantaneously impacted and trapped by the plastically deforming trapping particles 24 as it impacts the component; plastically deform and deposit into coating. The shock wave/compression waves pressure pulse is chosen to sufficiently reduce the interparticle spacing and to accelerate the particles to sufficient speeds to ensure trapping of the dry lubricant particles 22 by the trapping particles 24 onto the component 23 and form into coating.

Immediately after formation of the shockwave 38, the shockwave 38 travels toward the spraying end 36. The passage of the shockwave 38 induces flowing and heating of the quiescent gas 31 behind the shockwave 38. As mentioned above, the temperature generated by the shockwave 38 is lower than the predetermined temperature at which the dry lubricant 22 loses its dry lubricant properties.

The movement of the gas 31 (arrow 33) induces a movement of the dry lubricant particles 22 and trapping particles 24 with the shockwave 38 toward the spraying end 36. The velocity imparted to the dry lubricant particles 22 and trapping particles 24 is supersonic.

As the dry lubricant particles 22 and trapping particles 24 reach the spraying end 36, they exit the channel 32 at a velocity sufficient to cause plastic deformation of the trapping particles 24 at impact with the component 23 and form into coating. Particles 22, 24 are accelerated in the channel 32 to a range of speeds dependant on their particle size and density. The dry lubricant particles 22 should reach the component 23 at the same time or immediately before the trapping particles 24 so that the trapping particles 24 effectively trap the dry lubricant particles 22 onto the component 23, the dry lubricant particles 22 falling otherwise from the component 23.

When the dry lubricant particles 22 impact the component 23, the dry lubricant particles 22 shatter into numerous smaller particles, which each have a size smaller than the trapping particles 24. The trapping particles 24 plastically deform thereby bonding with the component 23 and the dry lubricant particles 22. As mentioned above, the choice of trapping particles 24 and component 23 will determine if the bonding is metallurgical, mechanical or both.

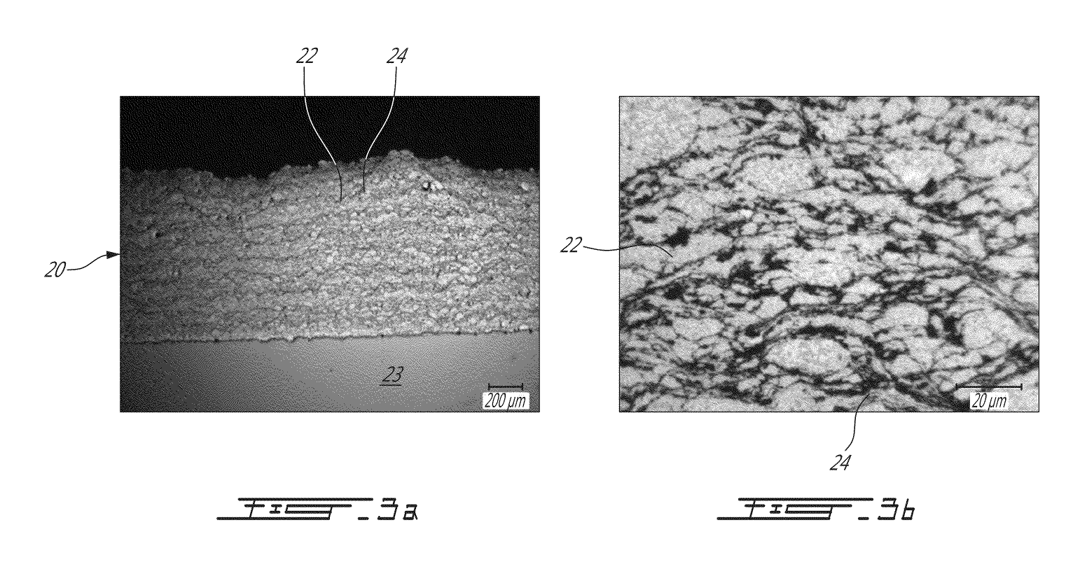

FIGS. 3a and 3b show an example of a cross-section and a close-up thereof of a deposition of dry lubricant particles 22 and trapping particles 24 onto the component 23. The dry lubricant particles 22 are particles of talc having a nominal size of 37 microns. The trapping particles 24 are particles of Al-12% Si having a nominal size of 23 microns. The proportion of dry lubricant particles 22 to trapping particles 24 is 22.2% ±3.5% of dry lubricant particles 22. The dry lubricant particles 22 are the darker zones in FIGS. 3a and 3b and the trapping particles 24 are the lighter zones. At deposition, the dry lubricant particles 22 have shattered into particles having a size of only 1 to 5 microns.

After passage of the shockwave 38, the gas 31 returns at a quiescent state. The above operation can be repeated cyclically to deposit the coating to desired thickness or to form a graded coating where a composition of the coating varies through its thickness.

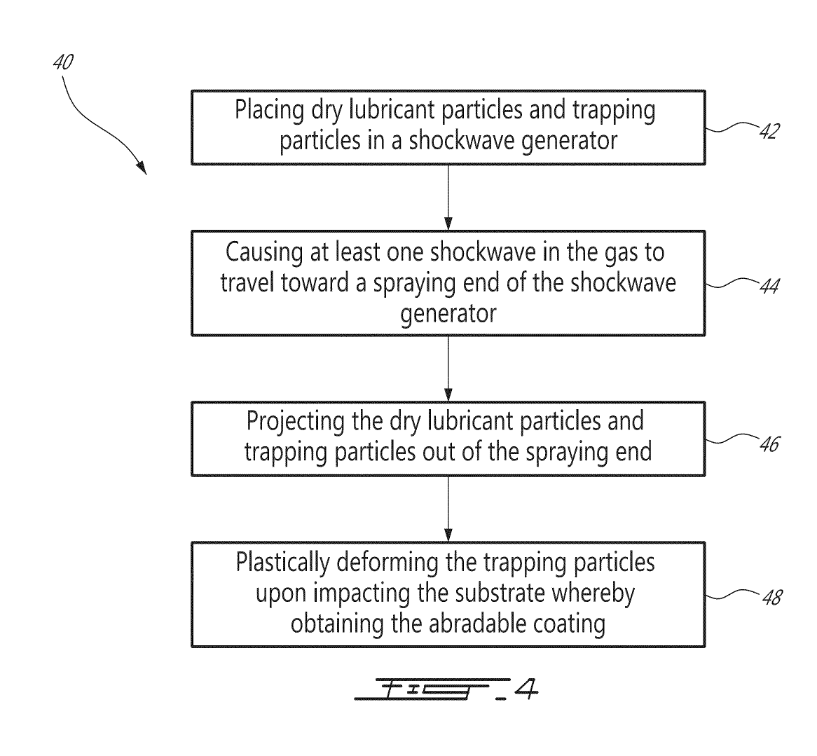

Turning now to FIG. 4, the method 40 of forming the abradable coating 20 using the shockwave generator 30 will now be described.

The method 40 starts at step 42 by placing the dry lubricant particles 22 and the trapping particles 24 in the channel 32 of the shockwave generator 30. As discussed above, the trapping particles 24 are plastically deformable to trap the dry lubricant particles 22 at impact.

From step 42, the method 40 goes to step 44, where shockwave 38 is generated in the gas 31 and travels along the channel 32 toward the spraying end 36. The shockwave 38 causes the dry lubricant particles 22 and trapping particles 24 to travel in the channel 32 with the shockwave 38 with reduced interparticle spacing.

From step 44, the method 40 goes to step 46, where the dry lubricant particles 22 and trapping particles 24 are projected from the spraying end 36 at a supersonic velocity.

From step 46, the method 40 goes to step 48, where the trapping particles 24 plastically deform upon impact of the dry lubricant particles 22 and the trapping particles 24 with the component 23. The abradable coating 20 is formed as a result of the plastically deformed trapping particles 24 trapping the dry lubricant particles 22 onto the component 23 thereby coating the component 23.

With the above method, an abradable surface can be formed with relatively little losses of dry lubricant particles. In addition, the temperature involved is so low that the dry lubricant particles do not oxidize/decompose and retain their dry lubricant properties. The above method reduces interparticle spacing, thereby enabling the plastically deformed trapping particles to trap the shattered particles of dry lubricant.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A method of forming an abradable coating on a gas turbine engine component, the method comprising, in sequence:
placing dry lubricant particles and trapping particles in a channel having a spraying end and containing a gas;
causing at least one shockwave in the gas to travel in the channel toward the spraying end, the at least one shockwave causing the dry lubricant particles and the trapping particles to travel in the channel with it, the at least one shockwave reducing interparticle spacing and increasing particles density;
directing a resulting flow of the dry lubricant particles and the trapping particles from the spraying end at a supersonic velocity to impact the component; and then
plastically deforming the trapping particles upon impacting the component with the resulting flow thereby trapping the dry lubricant particles with the deformed trapping particles onto the component to provide the abradable coating.

2. The method as defined in claim 1, wherein plastically deforming the trapping particles upon impacting the component comprises deforming the trapping particles to have a surface area larger than that of the dry lubricant particles.

3. The method as defined in claim 1, wherein placing the dry lubricant particles and the trapping particles in the channel comprises placing a composition of at least 50% of trapping particles.

4. The method as defined in claim 4, wherein placing dry lubricant particles and the trapping particles in the channel comprises placing a composition of 80% of trapping particles and 20% of dry lubricant particles.

5. The method as defined in claim 4, wherein placing dry lubricant particles and the trapping particles in the channel comprises placing a composition of 50% of trapping particles and 50% of dry lubricant particles.

6. The method as defined in claim 1, wherein trapping the dry lubricant particles onto the component with the plastically deformed trapping particles is a result of creating at least one of a metallurgical and mechanical bond between the dry lubricant and trapping particles and the component.

7. The method as defined in claim 1, wherein placing the dry lubricant particles and the trapping particles in the channel comprises placing a composition of talc and aluminum in the channel.

8. The method as defined in claim 1, wherein placing the dry lubricant particles and the trapping particles in the channel comprises placing dry lubricant particles of one of hexagonal boron nitride and talc.

9. The method as defined in claim 1, wherein placing the dry lubricant particles and the trapping particles in the channel comprises placing metal trapping particles in the channel.

10. The method as defined in claim 1, further comprising causing a plurality of compression waves to coalesce into at least one shockwave in the gas before causing the at least one shockwave to travel in the channel toward the spraying end.

11. The method as defined in claim 1, further comprising repeating the method with a different proportion of dry lubricant particles to trapping particles to obtain a graded abradable coating.

12. A method of forming an abradable coating on a gas turbine engine component, the method comprising supersonically spraying dry lubricant particles and trapping particles at the component to plastically deform the trapping particles upon the component to trap the dry lubricant particles, the trapped dry particles providing the abradable coating.

13. The method as defined in claim 12, wherein supersonically spraying dry lubricant particles and trapping particles at the component comprises causing the dry lubricant particles and the trapping particles to travel in with a shockwave thereby reducing interparticle spacing and increasing particle density.

14. The method as defined in claim 12, wherein supersonically spraying dry lubricant particles and trapping particles at the component comprises supersonically spraying a composition of at least 50% of trapping particles at the component.

15. The method as defined in claim 12, wherein supersonically spraying dry lubricant particles and trapping particles at the component comprises supersonically spraying a composition of 80% of trapping particles and 20% of dry lubricant particles at the component.

16. The method as defined in claim 12, further comprising plastically deform the trapping particles upon the component to trap the dry lubricant particles is a result of creating at least one of a metallurgical and mechanical bond between the dry lubricant and trapping particles and the component.

17. The method as defined in claim 12, wherein plastically deforming the trapping particles upon the component comprises deforming the trapping particles to have a larger surface area than that of the dry lubricant particles.
